(19) United States
(12) Patent Application Publication
(10) Pub. No.: US 2002/0020953 A1
(43) Pub. Date: Feb. 21, 2002

(54) Clamping tool

(76) Inventor: Bent Karsten Kofod, Kalundborg (DK)

Correspondence Address: PENNIE & EDMONDS LLP, 1667 K STREET NW, SUITE 1000, WASHINGTON, DC, 20006

(21) Appl. No.: 09/930,239

(22) Filed: Aug. 16, 2001

Related U.S. Application Data
(63) Continuation of application No. PCT/DK00/00064, filed on Feb. 17, 2000.

(30) Foreign Application Priority Data
Feb. 17, 1999 (DK) PA 1999 00206

(51) Int. Cl. B25B 1/14

(52) U.S. Cl. 269/228

(57) ABSTRACT

A clamping tool serving for clamping a workpiece on a support by means of a bar system constructed of a number of mutually pivotal bars comprising an activation bar for at operation making the bars pivot mutually between an initial position and a locking position, a clamping bar having at least one clamp shoe for pressing against the workpiece in the locking position of the bar system, and a base for mounting the bar system on the support. The bar system furthermore comprises two toggle joints arranged to simultaneously or almost simultaneously assume their dead point positions when the bar system at activation is taken from the initial position to the locking position. In the dead point positions the two toggle joints form an angle with each other. Thereby the clamping tool according to the invention is rendered capable of simultaneously acting on a workpiece which is to be clamped on a support with compressive forces in at least two directions so that the number of the clamping tools required for a given task can be reduced by one half compared to the number that is required when conventional clamping tools are used.

### CROSS-REFERENCE TO RELATED APPLICATIONS

The present application is a continuation of the U.S. National Stage designation of co-pending International Patent Application PCT/DK00/00064, filed Feb. 17, 2000. The entire contents of which is expressly incorporated herein by reference thereto.

### BACKGROUND OF THE INVENTION

The invention relates to a clamping tool for clamping a workpiece to a support by means of a bar system constructed of a number of mutually pivotal bars and comprising an activation bar for at operation making the bars pivot mutually between an initial position and a locking position, a clamping bar having at least one thrust shoe for pressing against the workpiece in the locking position of the bar system, and a base for mounting the bar system on the support.

Several different designs for such clamping tools are known that however have that in common that they are only able to exert pressure to a workpiece in one specific direction. Such a design is e.g. known from FR 260 1609. This invention relates to a system for immobilising a component located on the work table of machine tools.

In many cases, it is however necessary to clamp the workpiece in two directions, e.g. both a vertical and a horizontal. This is e.g. the case when a number of workpieces are to be welded together to a whole in a welding fixture, and each workpiece for this purpose must be positioned in two direction in order to obtain the accuracy that normally is required of such welded objects. Instead of one set of clamping tools, two sets have to be used, namely one set for clamping the workpieces in one direction and a second set for clamping the workpieces in a second direction.

The operation of the many clamping tools is labour-consuming and increases thereby the production costs. The doubling of the number of clamping tools furthermore means that the welding fixtures are expensive to produce.

### SUMMARY OF THE INVENTION

The object of the invention is to eliminate the above disadvantages of the known clamping tools by providing a clamping tool of the kind mentioned in the opening paragraph that is arranged in such a way that it is able to simultaneously act on a workpiece which is to be clamped to a support with compressive forces in at least two directions.

The novel and unique features according to the invention, whereby this is achieved, is the fact that the bar system comprises at least two toggle joints, that at lest two of these toggle joints are arranged to simultaneously or almost simultaneously assume their dead point positions when the bar system at activation is taken from the initial position to the locking position, and that said two toggle joints form an angle with each other in the dead point position.

By means of this arrangement of the clamping tool, a thrust shoe on the clamping bar can be made to act on a workpiece with a pressure in one direction while a second thrust shoe on the clamping bar simultaneously can act on the same workpiece with a pressure in a second direction.

A number of workpieces, which e.g. are to be welded together to form a whole in a welding fixture, can now be clamped securely and precisely in the fixture by means of normally half as many clamping tools as is required when conventional clamping tools are used. Thereby the task of clamping the workpieces and subsequently removing the finished, welded object from the fixture is facilitated and made less expensive, just as the costs for producing the fixture are reduced considerably.

The two joints of each toggle joint can according to the invention together form an angle which in the initial position of the bar system is pointing the point in the opposite direction of the thrust shoe, and the bar system can furthermore be arranged in such a way that its two toggle joints are put into their dead point positions by taking the bar system from the initial position towards the locking position. When the toggle joints during this approach the dead point positions, it will using a moderate manual force application on the handle of the bar system be possible to act on the workpiece that is to be clamped with considerable compressive forces in two direction at the same time. The maximum effect on the workpiece is obtained in the dead point positions in which the position of the whole bar system however is labile.

In the locking position of the bar system, each toggle joint is therefore taken beyond the dead point to a position in which its two joints together form an angle the point of which is pointing towards the thrust shoe. To maintain the great force application on the workpiece that is to be clamped, said angle is only a little smaller than 180°, e.g. 1°-2° smaller.

In an especially expedient and effective embodiment, the bar system according to the invention can comprise a first swivel connection for pivotally journaling one end of the activation bar in the base while the other end of the activation bar is free and serves as handle of the clamping tool; a rocking bar which at one end is pivotally journaled in the base via a second swivel connection which is nearer the at least one thrust shoe than the first swivel connection, and at the other end is pivotally journaled in the clamping bar via a third swivel connection; a first toggle joint having a first joint which at one end is pivotally journaled in the clamping bar via a fourth swivel connection which is farther from the at least one thrust shoe than the third swivel connection, and at the other end is pivotally journaled in the activation bar via a fifth swivel connection, and a second joint consisting of the part of the activation bar that is extending from the fifth to the first swivel connection; and a second toggle joint having a first joint which at one end is pivotally journaled in the rocking bar and/or clamping bar via a sixth swivel connection and at the other end is pivotally journaled in the activation bar via a seventh swivel connection which in the locking position of the clamping tool is nearer the at least one thrust shoe than the first and fifth swivel connection, and a second joint consisting of the part of the activation bar that is extending between the seventh and first swivel connection.

In one embodiment, the first joint of the second toggle joint can be pivotally connected to the clamping bar with the same swivel connection as the rocking bar while the first joint of the second toggle joint in a second embodiment can be pivotally connected to the rocking bar via a swivel connection another place on the bar. The first and second toggle joint can pass the dead point positions simultaneously when the bar system is taken from its initial position to its locking position. Thereby, the workpiece to be clamped is affected simultaneously in the two different pressure directions of the clamping tool. If the two toggle joints do not get to pass the dead points simultaneously, the workpiece can be clamped in one direction before it is finally clamped in a second direction. One of or each of the first joints of the two toggle joints can be shaped as a U with a bottom and two sides so that the bar system can be constructed compactly together.

### BRIEF DESCRIPTION OF THE DRAWINGS

The invention will be explained in greater detail below, describing only exemplary embodiments with reference to the drawing, in which:

FIG. 1 is a side elevational view of a clamping tool according to the invention in an initial position,

FIG. 2 shows the clamping tool in FIG. 1 in a locking position,

FIG. 3 is a back view of the clamping tool in FIGS. 1 and 2, and

FIG. 4 is a plan view of a clamping bar of the clamping tool.

### DETAILED DESCRIPTION OF THE PREFERRED EMBODIMENTS

Swivel connections will in the following for exemplary illustration be called swivel pins.

In the following it is assumed as an exemplary description of the invention that the clamping tool generally designated by the reference numeral 1 is to serve for clamping a workpiece 2 in a welding fixture 3 having a vertical contact face 4 and horizontal contact face 5.

The clamping tool comprises a base 6 with flaps 7 for mounting the base on the welding fixture by means of e.g. screws or welding (not shown). The clamping tool furthermore comprises a bar system 8 which is pivotally connected to the base. The bar system consists of a clamping bar 9, an activation bar 10 having a handle 11, a rocking bar 12, a first toggle joint 13 having a first joint 14 and a second joint 15, and a second toggle joint 16 having a first joint 17 and a second joint 18.

On the end of the clamping bar 9 opposite the activation bar 10 is mounted a clamp shoe 19 in the following called push shoe 19, and a clamp shoe 20 in the following called thrust shoe 20. Both clamp shoes are in the shown case shaped as screws that can be screwed on and adjusted in the clamping bar 9 by means of a not-shown screw connection.

As shown, the activation bar 10 is extending upwardly from the base 6 and is pivotally connected to this via swivel pins 21. The rocking bar 12 is also extending upwardly from the base and is pivotally connected to this via swivel pins 22 that are nearer the clamp shoes 19;20 than the swivel pins 21. At the other end the rocking bar is pivotally connected to the clamping bar via a swivel pin 23.

The first joint 14 of the first toggle joint 13 is at a larger distance from the clamp shoes 19;20 than the swivel pin 23 connected to the clamping bar 9 via a swivel pin 24. At the other end the first joint 14 of the first toggle joint 13 is pivotally connected to the activation bar 10 via swivel pins 25. The part of the activation bar that is between the swivel pins 25 and 21 forms the second joint 15 of the first toggle joint 13.

The first joint 17 of the second toggle joint 16 is at some point between the swivel pins 22 and 23 pivotally connected to the rocking bar 12 via swivel pins 26. At the other end the first joint 17 of the second toggle joint 16 is pivotally connected to the activation bar 10 via swivel pins 27. The part of the activation bar that is between the swivel pins 27 and 21 forms the second joint 18 of the second toggle joint 16.

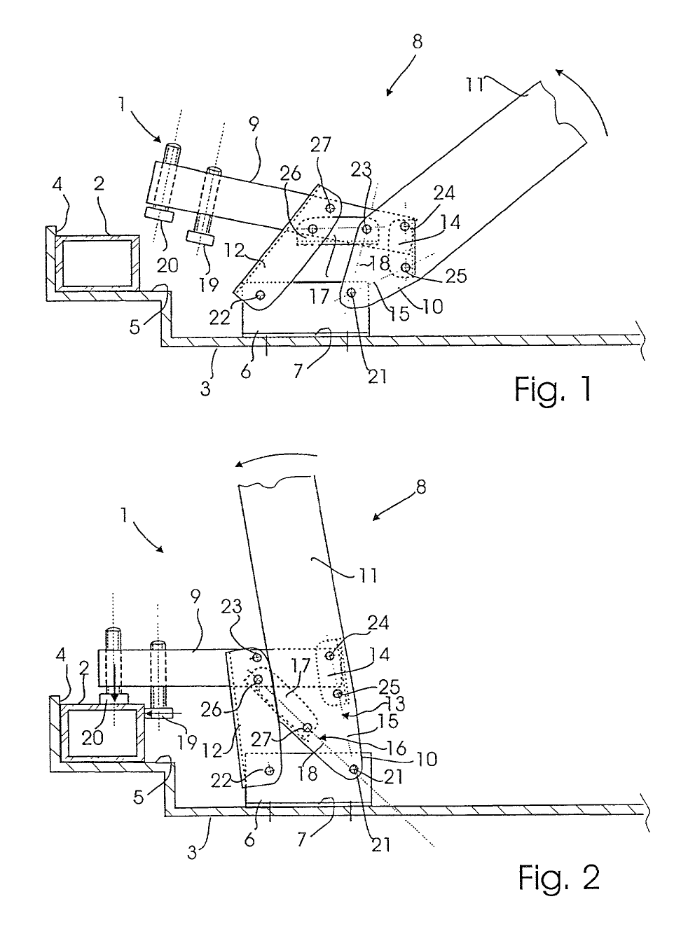

In FIG. 1 the bar system of the clamping tool is in the initial position with the clamp shoes 19;20 at a distance from the workpiece 2 which is to be clamped to the vertical and horizontal contact faces 4;5 of the welding fixture 3. The two joints 14 and 15 of the first toggle joint 13 together form, as shown, an angle with the peak point 25 pointing to the right in the figure, that is in the opposite direction of the clamp shoes 19 and 20. Also the two joints 17 and 18 of the second toggle joint 16 together form an angle with the peak point 27 pointing to the right in the figure.

By manually taking the handle 11 of the activation bar 10 in the direction of the arrow, the bars 9, 10, 12, 14 and 17 of the bar system 8 pivot about their respective swivel pins 21, 22, 23, 24, 25, 26 and 27 from the initial position in FIG. 1 to the locking position in FIG. 2. During this operation the rocking bar 12 pivots about its lower swivel pins 22 on the base 6 whereby the upper swivel pin 23 of the bar on the clamping bar 9 is made to describe an arch. At the same time the rearmost end of the clamping bar 9 is lifted up of the first toggle joint 13 which is straightened out. This combined motion means that the clamp shoes 19 and 20 are moving in an arch in over the workpiece 4. At the same time the second toggle joint 16 is also straightened out. Finally the push shoe 19 pushes the workpiece 2 in towards the vertical contact face 4 of the welding fixture 3 while the thrust shoe 20 presses the workpiece 2 down towards the horizontal contact face 5 of the welding fixture 3.

The bar system is arranged so that the two toggle joints 13 and 16 just passes their dead point positions in this final position. Thereby the bar system is locked as back pressures of the workpiece are not able to pivot the toggle joints back to their initial positions once they have passed the dead point positions.

In order for the clamp shoes 19 and 20 effectively to be able to clamp the workpiece 2 against the support 3, the considerable compressive forces that can be obtained in the dead point positions of the toggle joints must not be weakened very much when the toggle joints pass into the dead points, and the two joints 14;15 and 17;18 respectively of each toggle joint 13; 16 together form an angle that points its point in the direction towards the clamp shoes 19;20. This angle is therefore chosen to be between 175° and 180°, preferably between 177° and 180°, and especially between 178° and 180°.

As shown, the two toggle joints form in straightened position an angle in relation to each other. Thereby the bar system can absorb reaction forces in two directions. The vertical reaction force on the thrust shoe 20 is mainly transmitted via the first toggle joint 13 to the swivel pins 21 on the base 6 while the horizontal reaction force on the push shoe 19 is mainly transmitted via the second toggle joint 16 to the same swivel pin 21 on the base 6.

As it can be seen the clamping tool according to the invention can contrary to the conventional clamping tools thus clamp a workpiece securely and precisely in e.g. a welding fixture with forces that have effect in two different directions. The number of clamping tools can thereby be reduced by one half. Thereby considerable advantages are gained in that the task is facilitated and that the welding fixtures will be less expensive.

In the shown bar system the bars are constructed closely together. In order to under these conditions be able to give the bars the necessary strength and stability, the rocking bar 12 and the respective first joints 14 and 17 of the two toggle joints are each shaped as a U that allows for the placing and the mutual motion of the bars of the bar system.

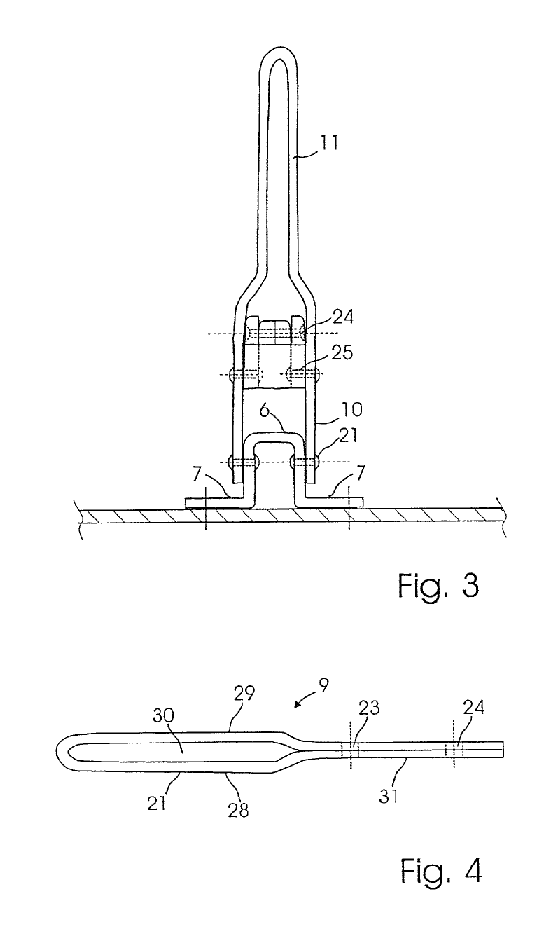

FIG. 3 shows that the activation bar 10 of the bar system is constructed as a fork which in order to form a good handle is more narrow at the top. It is furthermore shown that the base 6 is shaped as an inverted U with two fastening flaps 7 extending out to each their side from the U.

The clamping bar 9 consists in the case shown in FIG. 4 of a bent flat bar having two legs 28 and 29 that at the end near the clamp shoe leave a gap 30 between them for taking up the clamp shoes while the legs at the other end are placed close together and thereby forming a shank 31 for fitting in between the rest of the bars. In the shank are holes for the swivel pins 23 and 24.

What is claimed is:

1. A clamping tool for clamping a workpiece to a support by means of a bar system constructed of a number of mutually pivotal bars and comprising an activation bar for making the bars pivot mutually between an initial position and a locking position, a clamping bar having at least one thrust shoe for pressing against the workpiece in the locking position, and a base for mounting the bar system on the support, wherein the bar system furthermore comprises at least two toggle joints arranged to substantially simultaneously assume a dead point position when the bar system is taken from the initial position to the locking position, and further wherein said two toggle joints form an angle with each other in the dead point positions.

2. The clamping tool according to claim 1, wherein the two joints of each toggle joint together form an angle that points its point in the opposite direction of the at least one clamp shoe in the initial position of the bar system.

3. The clamping tool according to claim 1, wherein the two joints and respectively of each toggle joint together form an angle that point its point in a direction towards the at least one clamp shoe in the locking position of the bar system.

4. The clamping tool according to claim 3, wherein the angle that the two joints and respectively of each toggle joint form together in the locking position of the bar system is between 175° and 180°, preferably between 177° and 180°, and especially between 178° and 180°.

5. The clamping tool according to claim 1, wherein the bar system comprises a first swivel connection for pivotally journaling one end of the activation bar in the base while the other end of the activation bar is free and serves as handle for the clamping tool; a rocking bar which at one end is pivotally journaled in the base via a second swivel connection which is nearer the at least one clamp shoe than the first swivel connection and at the other end is pivotally journaled in the clamping bar via a third swivel connection; a first toggle joint having a first joint which at one end is pivotally journaled in the clamping bar via a fourth swivel connection which is farther from the at least one clamp shoe than the third swivel connection and at the other end is pivotally journaled in the activation bar via a fifth swivel connection, and a second joint consisting of the part of the activation bar that is extending from the fifth to the first swivel connection; and a second toggle joint having a first joint which at one end is pivotally journaled in the rocking bar and/or clamping bar via a sixth swivel connection and at the other end is pivotally journaled in the activation bar via a seventh swivel connection which in the locking position of the clamping tool is nearer the at least one clamp shoe than the first and the fifth swivel connection, and a second joint consisting of the part of the activation bar that is extending between the seventh and the first swivel connection.

6. The clamping tool according to claim 5, wherein the third and the sixth swivel connection coincide.

7. The clamping tool according to claim 5, wherein the sixth swivel connection is placed on the rocking bar between the second and the third swivel connection.

8. The clamping tool according to claim 1, wherein the first and the second toggle joint pass the dead point positions simultaneously when the bar system is taken from its initial position to its locking position.

9. The clamping tool according to claim 1, wherein the first and the second toggle joint do not pass the dead point positions simultaneously when the bar system is taken from its initial position to its locking position.

10. The clamping tool according to claim 1, wherein the first joint of the first and second toggle joint respectively is shaped as a U having a bottom and two sides.

11. A clamping tool comprising:
a base member;
a bar system mounted to the base member and comprising a plurality of mutually pivotal bars including:
an activation bar pivotally mounted to the base member and being provided with a handle member;
a racking bar also pivotally mounted to the base member and operatively connected to the activation bar via a first toggle joint; a clamping bar operatively connected to the activation bar via a second toggle joint and being pivotally mounted to said racking bar;
wherein the first and second toggle joints substantially simultaneously assume respective dead point positions, when the bar system is moved from a first, unlock position to a second, locked position.

12. The clamping tool according to claim 11, further comprising first and second clamping surfaces formed on the clamping member, said first and second clamping surfaces being directed substantially perpendicular to one another.

13. The clamping tool according to claim 12, further comprising first and second screws engaged to said clamping member wherein a first clamping surface is formed on said first screw and said second clamping surface is formed on said second screw.
